(19) United States
(12) Patent Application Publication
(10) Pub. No.: US 2009/0131108 A1
(43) Pub. Date: May 21, 2009

(54) SYSTEM AND METHOD FOR READING CONTACT LIST OF A MOBILE PHONE

(75) Inventor: KAI-YANG CHENG, Tu-Cheng (TW)

Correspondence Address: PCE INDUSTRY, INC.;ATT. Steven Reiss, 458 E. LAMBERT ROAD, FULLERTON, CA, 92835, US

(73) Assignee: CHI MEI COMMUNICATION SYSTEMS, INC., Tu-Cheng City (TW)

(21) Appl. No.: 12/147,518

(22) Filed: Jun. 27, 2008

(30) Foreign Application Priority Data
Nov. 15, 2007 (CN) 200710202556.9

(51) Int. Cl. H04B 1/38

(52) U.S. Cl. 455/558

(57) ABSTRACT

A method for reading contact list of a mobile phone includes the following steps of: reading a plurality of phone lists from a SIM card of the mobile phone and a memory of the mobile phone; storing each of the phone lists into a scratchpad memory of the mobile phone as different arrays when the mobile phone is powered on; triggering an element of the contact list of the mobile phone; confirming a phone list and a array corresponding to the element, and confirming a jth position of the element in the confirmed phone list; searching for an address of an element j in the confirmed array of the scratchpad memory according to the jth position of the element in the confirmed phone list; and reading contact list information from the address of the element j in the confirmed array.

### BACKGROUND OF THE INVENTION

1. Field of the Invention

The present invention generally relates to systems and methods for managing contact list, and particularly to a system and method for reading a contact list of a mobile phone.

2. Description of Related Art

Mobile phones provides a contact list and the contacts' information in the list may include information such as names and telephone numbers. This information on the contacts may appear on the mobile phone display for incoming calls or when making an outgoing call.

FIG. 4 shows a current storage architecture in related art of a scratchpad memory of a mobile phone. The contact list of the mobile phone includes a subscriber identity module (SIM) card phone list which is stored in an SIM card of the mobile phone, a memory phone list that is stored in a memory of the mobile phone, a system phone list that is composed of system phone numbers, and an emergency phone list that is composed of emergency phone numbers. When the mobile phone is powered on, an operating system of the mobile phone reads and stores the SIM card phone list, the memory phone list, the system phone list, and the emergency phone list into an array of the scratchpad memory of the mobile phone. The operating system also provides corresponding phone list indexes, such as a SIM card phone list index, a memory phone list index, a system phone list index, and an emergency phone list index, each of phone list indexes points to an address of a first element of the corresponding phone lists. For example, the SIM card phone list index points to an address of a first element SIM(1) of the SIM card phone list; the memory phone list index points to an address of a first element Mem(1) of the memory phone list; the system phone list index points to an address of a first element Sys(1) of the system phone list; the emergency phone list index points to an address of a first element Eme(1) of the emergency phone list. Furthermore, each element of the array stores an address of a next element of corresponding type phone list. For example, the first element SIM(1) of the SIM card phone list stores an address of second element SIM(2) of the SIM card phone list; the first element Mem(1) of the memory phone list stores an address of the second element Mem(2) of the memory phone list.

If the contact list of the mobile phone is sorted alphabetically, the contact list of the mobile phone also includes an alphabetized phone list, and the operating system of the mobile phone also stores the alphabetized phone list into the array when the mobile phone is powered on. The operating system also provides an alphabetized phone list index that points to an address of a first element Alp(1) of the alphabetized phone list. Furthermore, each element of the array also stores an address of a next element of the alphabetized phone list. For example, the first element Alp(1) of the alphabetized phone list stores an address of second element Alp(2) of the alphabetized phone list.

FIG. 5 is a flowchart of a method in related art for reading a contact list of the mobile phone from the current storage architecture of the scratchpad memory. The method includes the following steps of: triggering a desired element i of the contact list of the mobile phone by a user (Step S11); confirming a phone list and a corresponding phone list index of the element i (Step S12); finding an address of the first element pointed by the confirmed phone list index (Step S13); determining whether the found address has the desired element i of the contact list (Step S14); finding an address of a next element in the same type phone list if the found address has not the desired element i of the contact list (Step S15); and reading the contact list information from the found address if the found address has the desired element i (Step S16). However, the method has some disadvantages, such as it is time consuming and the scratchpad uses an inordinate amount of memory to provide spaces to store corresponding addresses of next elements.

Accordingly, what is needed is a system and method for rapidly reading the contact list information from the scratchpad memory of a mobile phone.

### SUMMARY

An exemplary embodiment provides a method for reading contact list of a mobile phone. The method includes: reading a plurality of phone lists from a SIM card of the mobile phone and a memory of the mobile phone; storing each of the phone lists into a scratchpad memory of the mobile phone as different arrays when the mobile phone is powered on; triggering an element of the contact list of the mobile phone; confirming a phone list and a array corresponding to the element, and confirming a jth position of the element in the confirmed phone list; searching for an address of an element j in the confirmed array of the scratchpad memory according to the jth position of the element in the confirmed phone list; and reading contact list information from the address of the element j in the confirmed array.

Other systems, methods, features, and advantages will be or become apparent to one skilled in the art upon examination of the following drawings and detailed description.

### BRIEF DESCRIPTION OF THE DRAWINGS

FIG. 1 is a functional block diagram of a system for reading a contact list of a mobile phone in accordance with an exemplary embodiment.

FIG. 2 shows a storage architecture of a scratchpad memory of the mobile phone in accordance with the exemplary embodiment.

FIG. 3 is a flowchart of a method for reading a contact list of a mobile phone in accordance with the exemplary embodiment.

FIG. 4 shows a current storage architecture in related art of a scratchpad memory of a mobile phone.

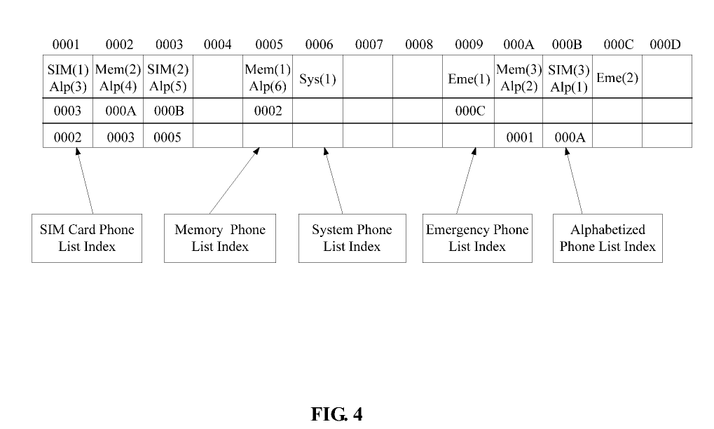

FIG. 5 is a flowchart of a method in related art for reading a contact list of the mobile phone from the current storage architecture of the scratchpad memory.

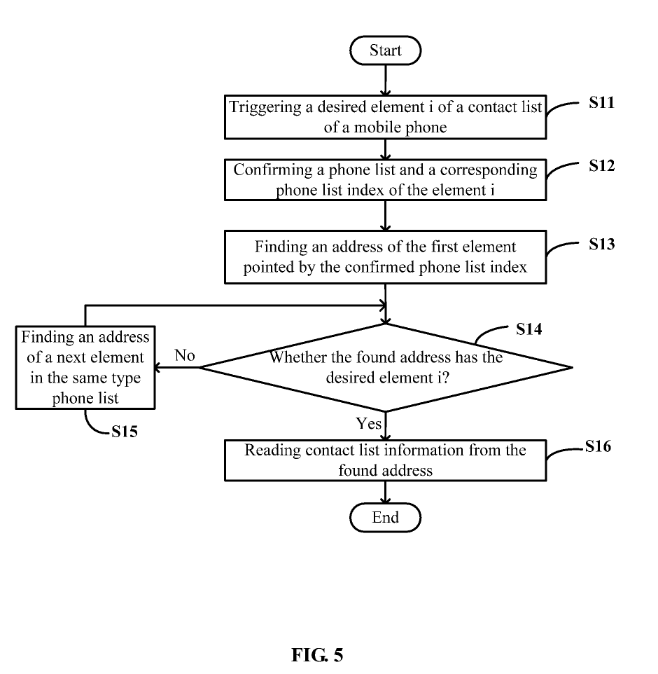

### DETAILED DESCRIPTION OF THE EMBODIMENTS

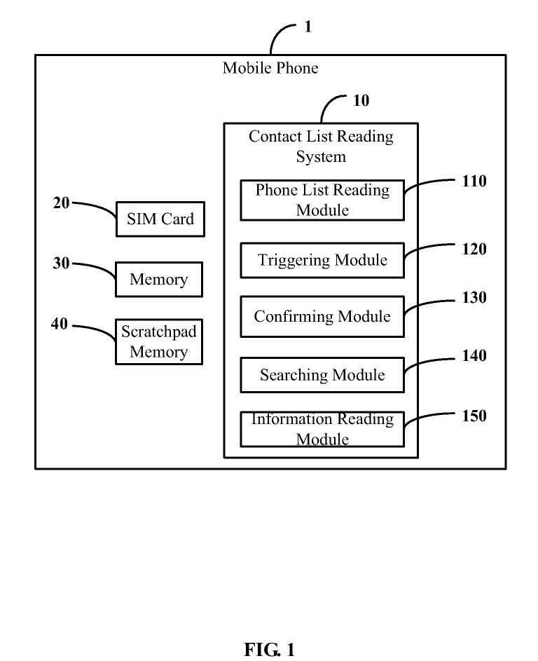

FIG. 1 is a functional block diagram of a system for reading a contact list of a mobile phone (hereinafter, “the contact list reading system 10”) in accordance with an exemplary embodiment. The contact list reading system 10 is installed and executable in a mobile phone 1, which further includes a subscriber identity module (SIM) card 20, a memory 30, and a scratchpad memory 40. In the exemplary embodiment, the contact list of the mobile phone 1 may include, but not limited to, a SIM card phone list which is stored in the SIM card 20, a memory phone list which is stored in the memory 30, a system phone list which is composed of system phone numbers, an emergency phone list which is composed of emergency phone numbers, and an alphabetized phone list.

The contact list reading system 10 includes a phone list reading module 110, a triggering module 120, a confirming module 130, a searching module 140, and an information reading module 150.

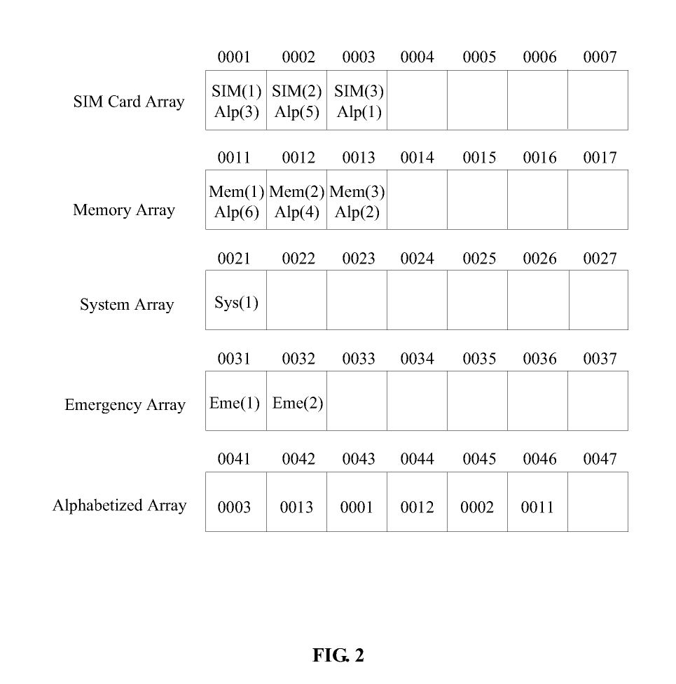

The phone list reading module 110 is configured for reading a plurality of phone lists from the SIM card 20 and the memory 30, and storing the phone lists into the scratchpad memory 40 as different arrays when the mobile phone 1 is powered on. In the exemplary embodiment, each element in the arrays stores contact list information, such as names, phone numbers, and email addresses. For example, FIG. 2 shows storage architecture of the scratchpad memory 40 in accordance with the exemplary embodiment. When the mobile phone 1 is powered on, the phone list reading module 110 reads the SIM card phone list, the memory phone list, the system phone list, the emergency phone list, and the alphabetized phone list from the SIM card 20 and/or the memory 30, stores the SIM card phone list into the scratchpad memory 40 as a SIM card array, stores the memory phone list into the scratchpad memory 40 as a memory array, stores the system phone list into the scratchpad memory 40 as a system array, stores the emergency phone list into the scratchpad memory 40 as an emergency array, and stores the alphabetized phone list into the scratchpad memory 40 as a name array. Elements SIM(1), SIM(2), and SIM(3) of the SIM card array are stored in addresses “0001,” “0002,” and “0003” correspondingly. Elements Mem(1), Mem(2), and Mem(3) of the memory array are stored in addresses “0011,” “0012,” and “0013” correspondingly. Element Sys(1) of the system array is stored in an address “0021”. Elements Eme(1), Eme(2) of the emergency array are stored in an address “0031,” and “0032”. According to the alphabetized phone list, first six elements Alp(1), Alp(2), Alp(3), Alp(4), Alp(5), Alp(6) are equal to the elements SIM(3), Mem(3), SIM(1), Mem(2), SIM(2), Mem(1) correspondingly. Thus, first six elements of the name array are the addresses of the elements SIM(3), Mem(3), SIM(1), Mem(2), SIM(2), Mem(1) correspondingly.

The triggering module 120 is configured for triggering an element of the contact list of the mobile phone 1 by a user.

The confirming module 130 is configured for confirming a phone list and an array corresponding to the element, and confirming a jth position of the element in the confirmed phone list.

The searching module 140 is configured for searching for an address of an element j in the confirmed array of the scratchpad memory 40 according to the jth position of the element in the confirmed phone list.

The information reading module 150 is configured for reading contact list information from the address of the element j in the confirmed array, and displaying the read contact list information in a screen of the mobile phone 1.

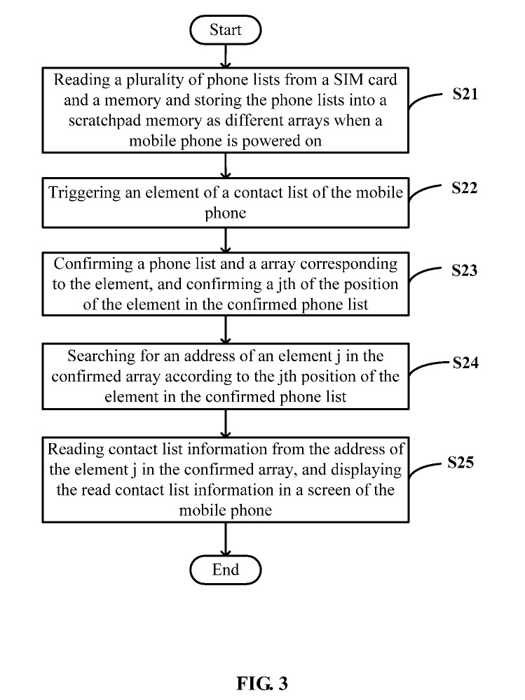

FIG. 3 is a flowchart of a method for reading a contact list of a mobile phone in accordance with the exemplary embodiment.

In step S21, the phone list reading module 110 reads a plurality of phone lists from the SIM card 20 and the memory 30 and stores the phone lists into the scratchpad memory 40 as different arrays when the mobile phone 1 is powered on. In the exemplary embodiment, the phone list reading module 110 reads the SIM card phone list, the memory phone list, the system phone list, the emergency phone list, and the alphabetized phone list from the SIM card 20 and/or the memory 30, stores the SIM card phone list into the scratchpad memory 40 as a SIM card array, stores the memory phone list into the scratchpad memory 40 as a memory array, stores the system phone list into the scratchpad memory 40 as a system array, stores the emergency phone list into the scratchpad memory 40 as an emergency array, and stores the alphabetized phone list into the scratchpad memory 40 as a name array.

In step S22, the triggering module 120 triggers an element of the contact list of the mobile phone 1.

In step S23, the confirming module 130 confirms a phone list and an array corresponding to the element, and confirms a jth position of the element in the confirmed phone list.

In step S24, the searching module 140 searches for the address of an element j in the confirmed array of the scratchpad memory 40 according to the jth position of the element in the confirm phone list.

In step S25, the information reading module 150 reads contact list information from the address of the element j in the confirmed array, and displays the read contact list information in the screen of the mobile phone 1.

It should be emphasized that the above-described embodiments of the exemplary embodiments are merely possible examples of implementations, merely set forth for a clear understanding of the principles of the invention. Many variations and modifications may be made to the above-described exemplary embodiment without departing substantially from the spirit and principles of the invention. All such modifications and variations are intended to be included herein within the scope of this disclosure and the above-described exemplary embodiment and protected by the following claims.

What is claimed is:

1. A system for reading contact list of a mobile phone, which comprises a SIM card, a memory, and a scratchpad memory, the system comprising:
a phone list reading module configured for reading a plurality of phone lists from the SIM card and the memory, and storing each of the phone lists into the scratchpad memory as different arrays when the mobile phone is powered on;
a triggering module configured for triggering an element of the contact list of the mobile phone;
a confirming module configured for confirming a phone list and an array corresponding to the element, and confirming a jth position of the element in the confirmed phone list;
a searching module configured for searching for an address of an element j in the confirmed array of the scratchpad memory according to the jth position of the element in the confirmed phone list; and
an information reading module configured for reading contact list information from the address of the element j in the confirmed array.

2. The system according to claim 1, wherein the phone lists comprises a SIM card phone list, a memory phone list, a system phone list, an emergency phone list, and an alphabetized phone list.

3. The system according to claim 2, wherein the phone list reading module stores the SIM card phone list into the scratchpad memory as a SIM card array, stores the memory phone list into the scratchpad memory as a memory array, stores the system phone list into the scratchpad memory as a system array, stores the emergency phone list into the scratchpad memory as an emergency array, and stores the alphabetized phone list into the scratchpad memory as a name array.

4. The system according to claim 1, wherein the information reading module is further configured for displaying the read contact list information in a screen of the mobile phone.

5. A method for reading contact list of a mobile phone, the method comprising:
reading a plurality of phone lists from a SIM card of the mobile phone and a memory of the mobile phone;
storing each of the phone lists into a scratchpad memory of the mobile phone as different arrays when the mobile phone is powered on;
triggering an element of the contact list of the mobile phone;
confirming a phone list and an array corresponding to the element, and confirming a jth position of the element in the confirmed phone list;
searching for an address of an element j in the confirmed array of the scratchpad memory according to the jth position of the element in the confirmed phone list; and
reading contact list information from the address of the element j in the confirmed array.

6. The method according to claim 5, wherein the phone lists comprises a SIM card phone list, a memory phone list, a system phone list, an emergency phone list, and an alphabetized phone list.

7. The method according to claim 6, wherein the storing step further comprising:
storing the SIM card phone list into the scratchpad memory as a SIM card array;
storing the memory phone list into the scratchpad memory as a memory array;
storing the system phone list into the scratchpad memory as a system array;
storing the emergency phone list into the scratchpad memory as an emergency array; and
storing the alphabetized phone list into the scratchpad memory as a name array.

8. The method according to claim 5, wherein the method further comprising:
displaying the read contact list information in a screen of the mobile phone.
